(19) United States
(12) Patent Application Publication
(10) Pub. No.: US 2022/0330502 A1
(43) Pub. Date: Oct. 20, 2022

(54) Plant Growing System

(71) Applicant: Steam Tech, LLC, Denver, CO (US)

(72) Inventors: Philip Hartman, Windsor, CO (US); James Hartman, Loveland, CO (US)

(73) Assignee: Steam Tech, LLC, Denver, CO (US)

(21) Appl. No.: 17/717,993

(22) Filed: Apr. 11, 2022

Related U.S. Application Data
(60) Provisional application No. 63/174,450, filed on Apr. 13, 2021.

(51) Int. Cl. A01G 31/02; A01G 9/24

(52) U.S. Cl. CPC A01G 31/02; A01G 9/249

(57) ABSTRACT

A plant growing system including a plant growing apparatus and methods of making and using the plant growing apparatus to control at least one physical condition of the environment to cultivate plants in plant growing trays associated with the plant growing apparatus.

This United States Non-Provisional Patent application claims the benefit of U.S. Provisional Patent Application No. 63/174,450, filed Apr. 13, 2021, hereby incorporated by reference herein.

### I. FIELD OF THE INVENTION

A plant growing system including a plant growing apparatus and methods of making and using the plant growing apparatus to control at least one physical condition of the environment to cultivate plants in plant growing trays associated with the plant growing apparatus.

### II. SUMMARY OF THE INVENTION

A broad object of embodiments of the invention can be to provide plant growing apparatus that controls at least one physical condition of the environment to cultivate plants in plant growing trays, the plant growing apparatus including one or more of: an X axis head movement mechanism, a Y axis head movement mechanism, or an X-Y axis head movement mechanism, operable to move one or more head units in spatial relation to each of the one or more plant growing trays supported by the plant growing apparatus, wherein each head unit includes one or more of: one or more light emitters adapted to emit light to illuminate one or more plant growing trays, a nozzle adapted to dispense a fluid to one or more plant growing trays, a tray data sensor to sense machine readable tray data on each of the one or more plant growing trays, a tray proximity sensor or tray color sensor that respectively generate proximity or color data correlatable with plant growth associated with each of the one or more plant growing trays, an image capture device that generates image capture data correlatable with plant growth associated with each of the one or more plant growing trays or for depiction on the display surface of a computing device.

Another broad object of the invention can be to provide a controller including a processor in communication with a non-transitory computer readable medium containing a plant growing program operable to control the movement of the X axis, Y axis or X-Y axis head movement mechanism to correspondingly move one or more head units in spatial relation to each of one or more plant growing trays supported by the plant growing apparatus, and control operation of the one or more components associated with the head unit including wavelength frequency or wavelength amplitude of emitted light emitted by one or more light emitters, the periodicity and amount of fluid discharged from the nozzle, acquisition and processing of one or more of: tray data on each of the one or more plant growing trays, a tray proximity data or tray color data correlatable with plant growth associated with each of the one or more plant growing trays, and image capture data correlatable with plant growth associated with each of the one or more plant growing trays or depiction on the display surface of a computing device.

Naturally, further objects of the invention are disclosed throughout other areas of the specification, drawings, photographs, and claims.

### III. A BRIEF DESCRIPTION OF THE DRAWINGS

FIG. 1 is a block diagram of an illustrative computer means, network means and computer-readable media which provides computer-executable instructions to implement an embodiment of a plant growing system.

FIG. 2 is a front elevation perspective view of a particular embodiment of a plant growing apparatus.

FIG. 3 is a front elevation perspective view of another particular embodiment of a plant growing apparatus.

FIG. 4 is a front elevation view of the particular embodiment of the plant growing apparatus shown in FIG. 3 having the front external panel removed from the supporting framework of the plant growing apparatus.

FIG. 5 is a rear elevation view of the particular embodiment of the plant growing apparatus shown in FIG. 3 having the rear external panel removed from the supporting framework of the plant growing apparatus.

FIG. 6 is a first side elevation view of the particular embodiment of the plant growing apparatus shown in FIG. 3 having the first side external panel removed from the supporting framework of the plant growing apparatus.

FIG. 7 is a second side elevation view of the particular embodiment of the plant growing apparatus shown in FIG. 3 having the second side external panel removed from the supporting framework of the plant growing apparatus.

FIG. 8 is a top perspective view of the particular embodiment of the plant growing apparatus shown in FIG. 3 having the top external panel removed from the supporting framework of the plant growing apparatus.

FIG. 9 is a bottom perspective view of the particular embodiment of the plant growing apparatus shown in FIG. 3 having the bottom external panel installed on the supporting framework of the plant growing apparatus.

FIG. 10 is a is a rear elevation view of the particular embodiment of the plant growing apparatus shown in FIG. 2 having the rear external panel removed from the plant growing apparatus.

FIG. 11 is a cross section view 11-11 as shown respectively in FIGS. 10 and 11.

FIG. 12 is bottom perspective view of a particular embodiment of a head unit movable in spatial relation to one or more plant growing trays positioned on shelves in the plant growing apparatus as depicted in either FIG. 2 or FIG. 3.

FIG. 13 is perspective view of a portion of a X-Y axis head movement mechanism including a platen from which the particular embodiment of the head unit shown in FIG. 12 extends along with a particular embodiment of a 2 position 3 way normally open solenoid valve which controls first and second fluid flows to the head unit.

FIG. 14 is a cross section view 14-14 of the embodiment of the head unit shown in FIG. 12.

FIG. 15 is a bottom perspective view of a particular embodiment of the head unit including a nozzle, an optical window, tray data sensor, a proximity or color sensor, and an image capture device.

FIG. 16 is a top perspective view of an embodiment of the head unit.

FIG. 17 is a top plan view of an embodiment of the head unit.

FIG. 18 is a bottom plan view of an embodiment of the head unit.

FIG. 19 is a first end elevation view of an embodiment of the head unit.

FIG. 20 is a second end elevation view of an embodiment of the head unit.

FIG. 21 is a first side elevation view of an embodiment of the head unit.

FIG. 22 is a second side elevation view of an embodiment of the head unit.

FIG. 23 is a cross section view 21-21 of the embodiment of the head unit as shown in FIG. 18.

FIG. 24 is perspective view of another particular embodiment of the head unit movable in spatial relation to one or more plant growing trays positioned on shelves in the plant growing apparatus as depicted either in FIG. 2 or FIG. 3.

FIG. 25 is top plan view of the particular embodiment of the head unit depicted in FIG. 24.

FIG. 26 is a bottom perspective view of the particular embodiment of head unit depicted in FIG. 24 having the bottom cover removed.

FIG. 27 is a cross section view 27-27 shown in FIG. 25.

FIG. 28 is a perspective view of an embodiment of a tray having tray data elements disposed on the tray sidewall rim.

FIG. 29 is a perspective view of an embodiment of a tray lid.

FIG. 30 is a cross section view of the tray lid engaged with the tray to retain the plant growing medium containing seeds inside the enclosed tray interior space.

FIG. 31 is a is a cross section view of a plurality of trays disposed in stacked relation.

### IV. DETAILED DESCRIPTION OF THE PREFERRED EMBODIMENTS

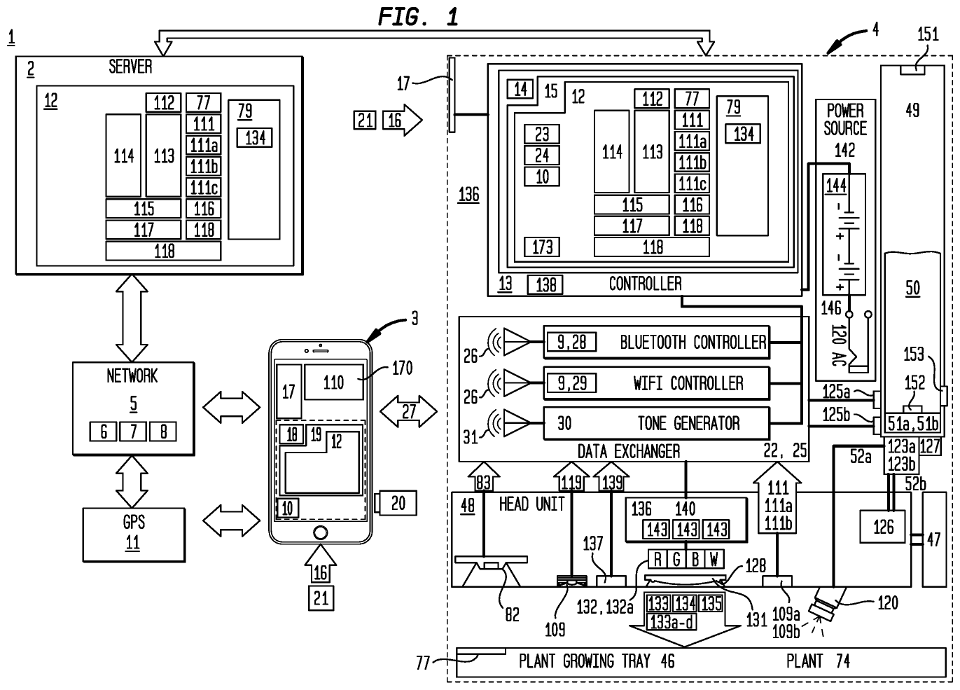

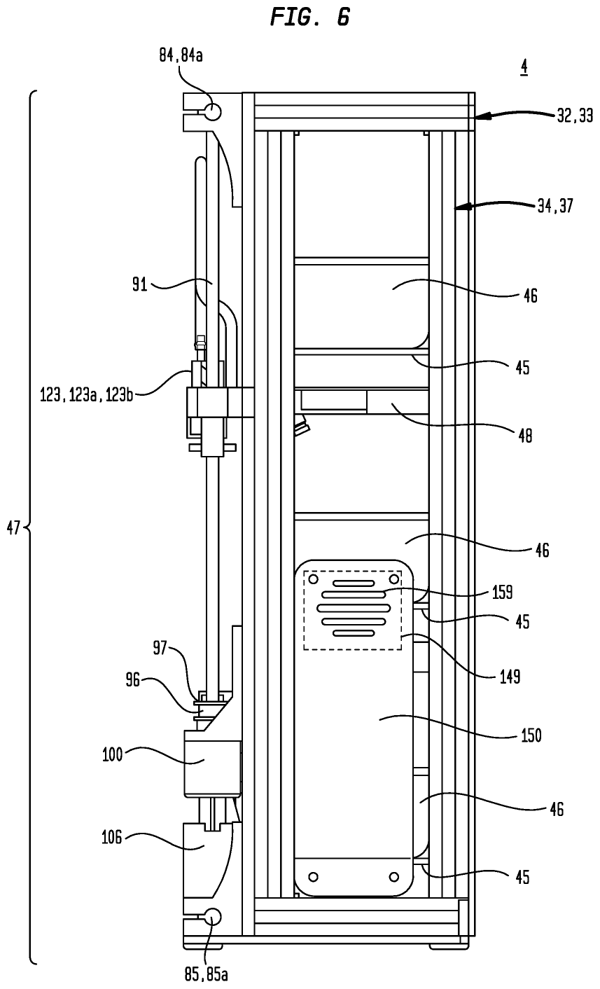

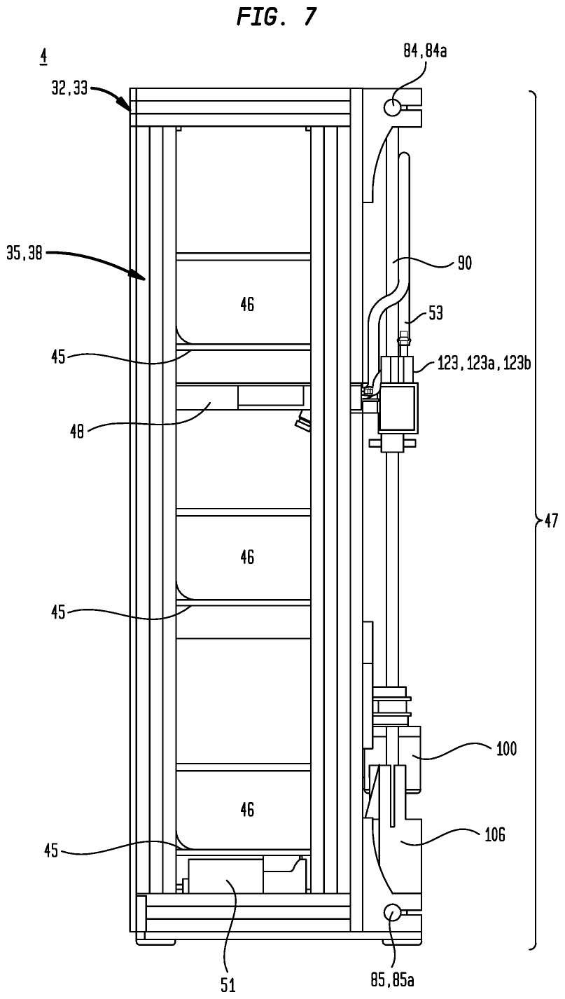

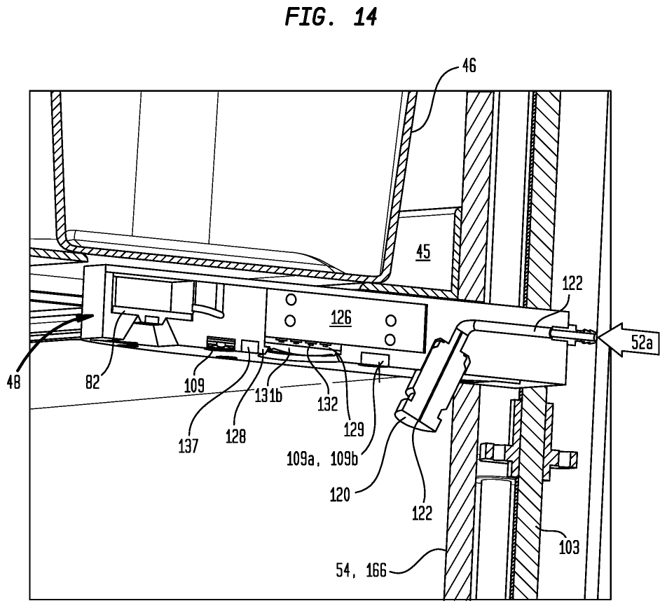

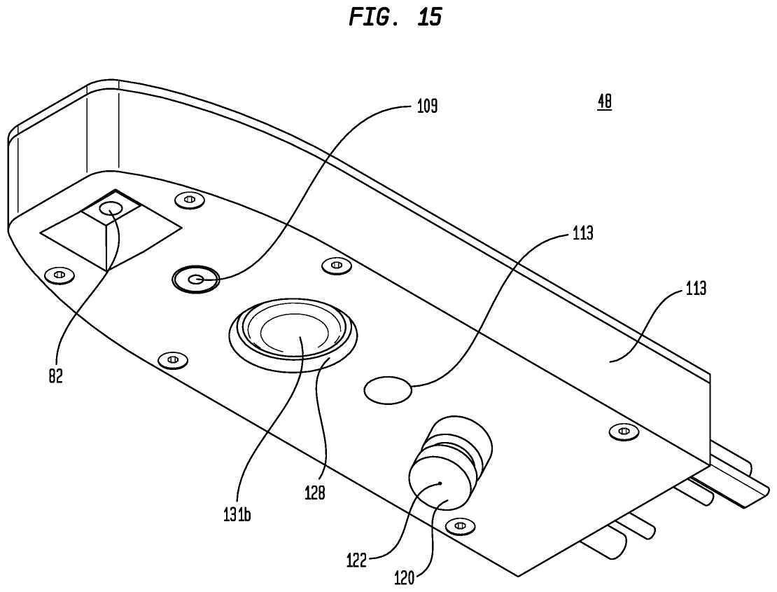

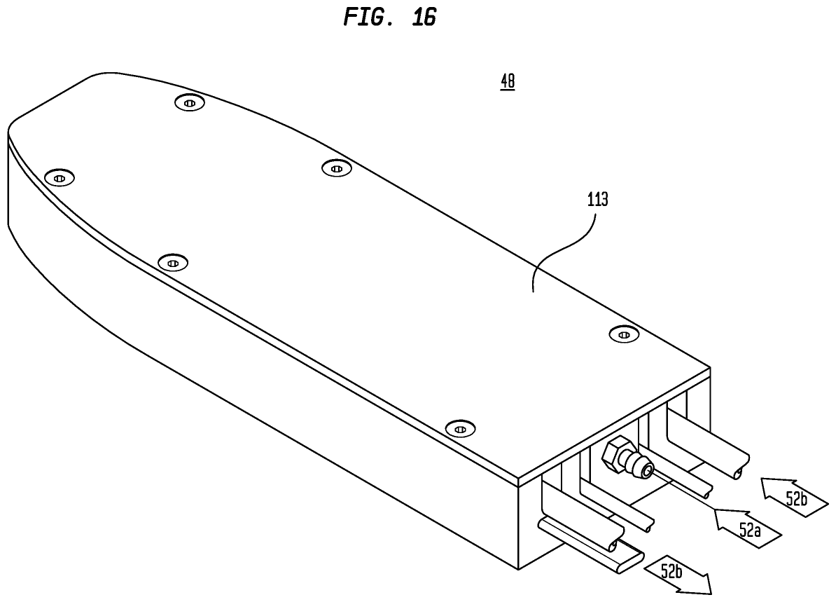

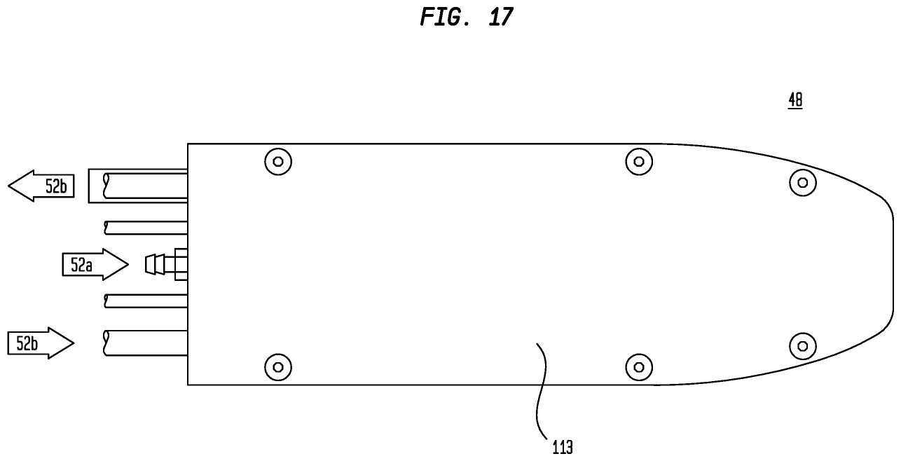

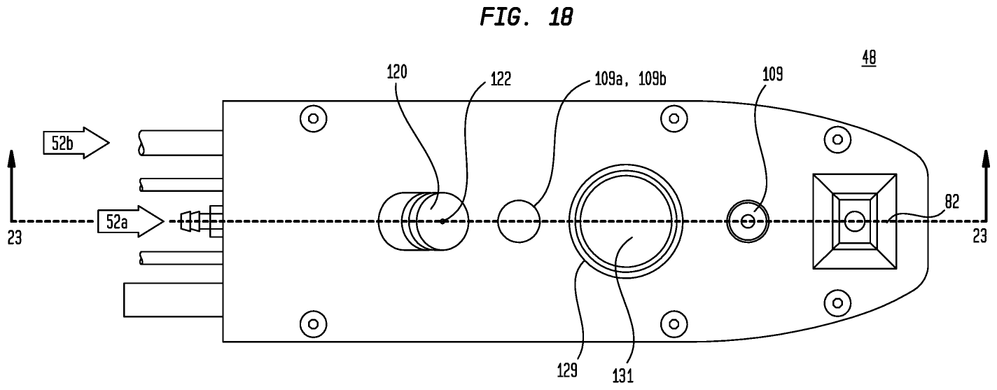

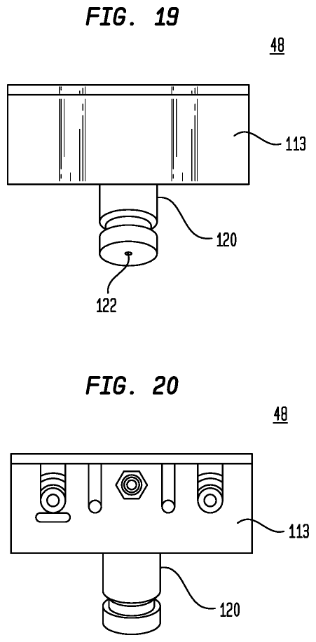

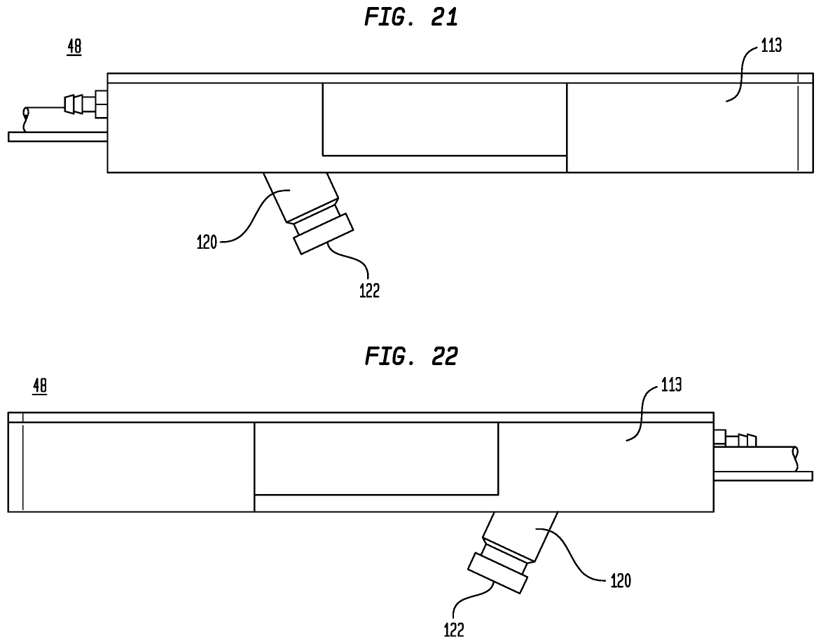

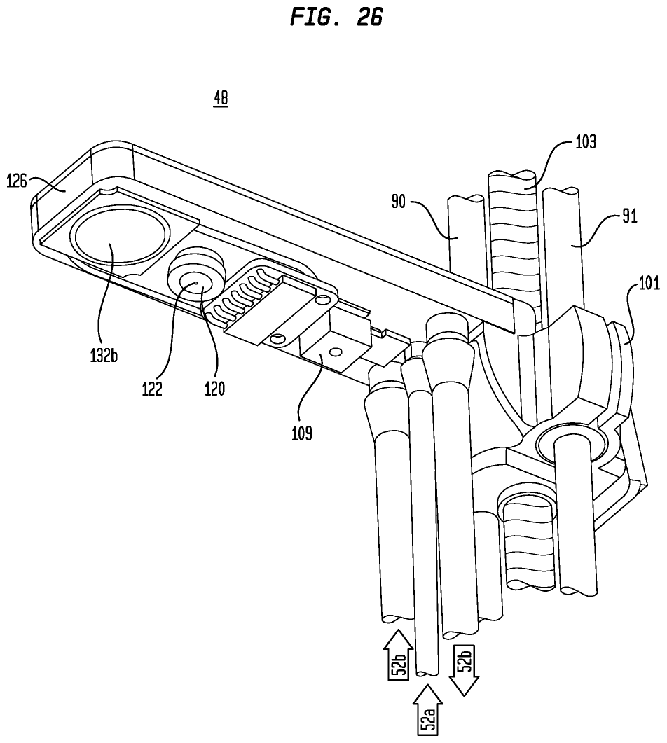

The System. Generally, with primary reference to FIGS. 1 through 25, a plant growing system (1) (also referred to as the “system (1)”) can in various combinations include one or more servers (2) operably communicatively coupled to one or more computing devices (3) or one or more plant growing apparatuses (4), or both computing devices (3) and plant growing apparatus (4) by a public network (5), such as the Internet (6), a cellular-based wireless network(s) (7), or a local network (8) (individually or collectively the “network” (5)) or short range frequency bands (9). Each computing device (3) or each plant growing apparatus (4) can further include a global positioning receiver (10) operably coupled to a global positioning system (“GPS”) (11). While the terms “computing device” and “plant growing apparatus” are utilized in combination with certain embodiments, this is not intended to limit the scope of the invention to those particular embodiments, rather, certain embodiments may include only the plant growing apparatus (4), or only a computing device (3), or one or more plant growing apparatuses (4) operably coupled to one or more computing devices (3) through the network (5) as above described. The network (5) can, but need not necessarily, support a plant growing apparatus control program (12) (also referred to as the “program (12)”) accessible by browser based on-line processing or downloadable by one or more computing devices (3) or one or more plant growing apparatuses (4). In particular embodiments, the system (1) can coordinate communication between one or more computing devices (3) and one or more plant growing apparatuses (4) to establish on-line or off-line wired or wireless control of one or more plant growing apparatuses (4) and one or more computing devices (3). In particular embodiments, a computing device (3) can communicate with a plant growing apparatus (4) over short range frequency bands (9) to activate the various functions of a plant growing apparatus controller (13) which may include a controller processor (14) in communication with a controller non-transitory computer readable medium (15) containing in whole or in part the program (12). In particular embodiments, the plant growing apparatus (4) can be a unitary device including the plant growing apparatus controller (13) having the processor (14) and the non-transitory computer readable medium (15) containing the program (12) that can be activated by user indications (16) in a plant growing apparatus user interface (17) accessibly mounted on the plant growing apparatus (4).

Plant(s). For the purposes of this invention, the term “plant” broadly encompasses any member of the kingdom Plantae, comprising multicellular organisms that produce their own food from inorganic matter by the process of photosynthesis and that have more or less rigid cell walls containing cellulose, including as illustrative examples vascular plants, mosses, liverworts, and hornworts, but for the purposes of this invention the term plant can further include: fungi, algae, bacteria, blue-green algae, and certain single-celled eukaryotes that have may plantlike qualities, such as rigid cell walls or photosynthesis.

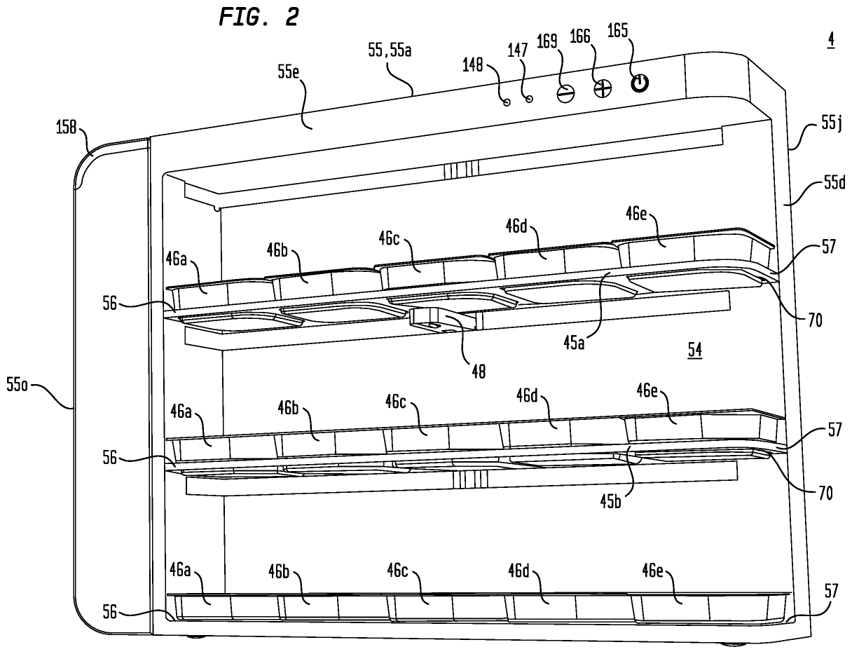

The Computing Device. Now, with primary reference to FIGS. 1 and 2, a computing device (3) can include a computing device processor (18) communicatively coupled to a computing device non-transitory computer readable media (19). The computing device (3) can access the program (12) being served by the server (2) via the network (5) or can contain in the computing device non-transitory readable media (19) computer executable instructions including the program (12) to implement the functionalities of the computing device (3) and the plant growing apparatus (4) in a system (1) without a remote server (2). The computing device (3) can as illustrative examples be: a desktop computer device or a mobile computer device, such as, personal computers, slate computers, tablet or pad computers, cellular telephones, personal digital assistants, smartphones, programmable consumer electronics, or combinations thereof. The program (12) accessed through the network (5) or from other computer readable medium (20) by the computing device (3) can allow a user (21) access to the functionalities of the system (1) or the plant growing apparatus (4) whether on-line or off-line depending on the application. In particular embodiments, the program (12) can operate an electronic data exchanger (22) which functions to transmit pairing information (23) between one or more computing devices (3) and one or more plant growing apparatuses (4). In particular embodiments, the computing device (3) or the plant growing apparatus (4) or both can further include a radio frequency controller (24) which operates a radio frequency transmitter (25) to cause wireless connection or pairing of one or more computing devices (3) with one or more plant growing apparatuses (4) over one or more short-range radio frequency bands (9) to carry a signal (26) over all or a part of the communication path (27) between the one or more computing devices (3) and the one or more plant growing apparatuses (4). The short-range frequency bands (9) can include as illustrative examples: BLUETOOTH® (28) which operates at frequencies of about 2402 MHz to about 2480 MHz or about 2400 MHz to about 2483.5 MHz or WI-FI® (29) which operates at about 2.4 GHz or 5 GHz, and in particular embodiments, between 115 MHz to 858 MHz range or the 862 MHz to 870 MHz range depending on the region or territory of use. In other particular embodiments, the computing device (3) or the plant growing apparatus (4) can, but need not necessarily, include a tone generator (30) which generates tones (31) also referred to as an “audio beacon.”

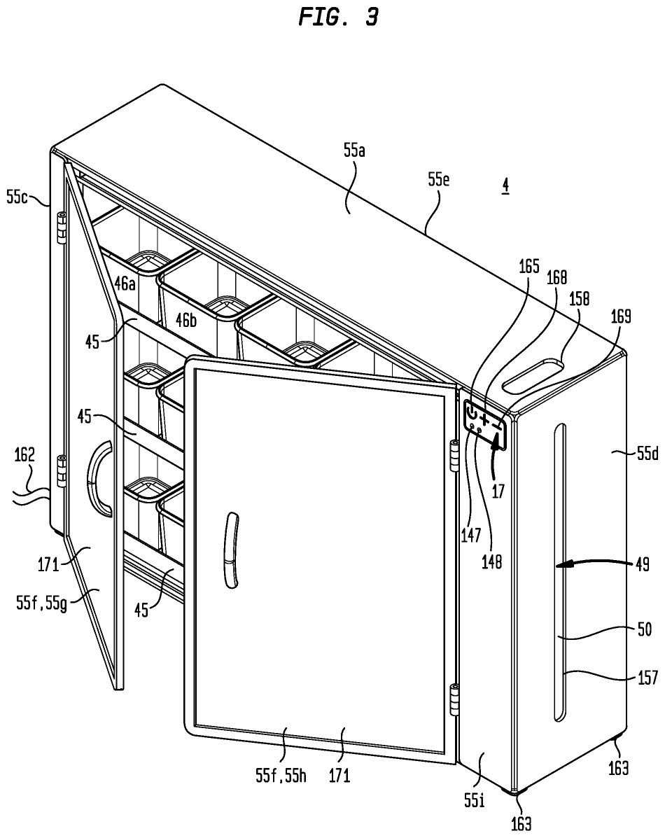

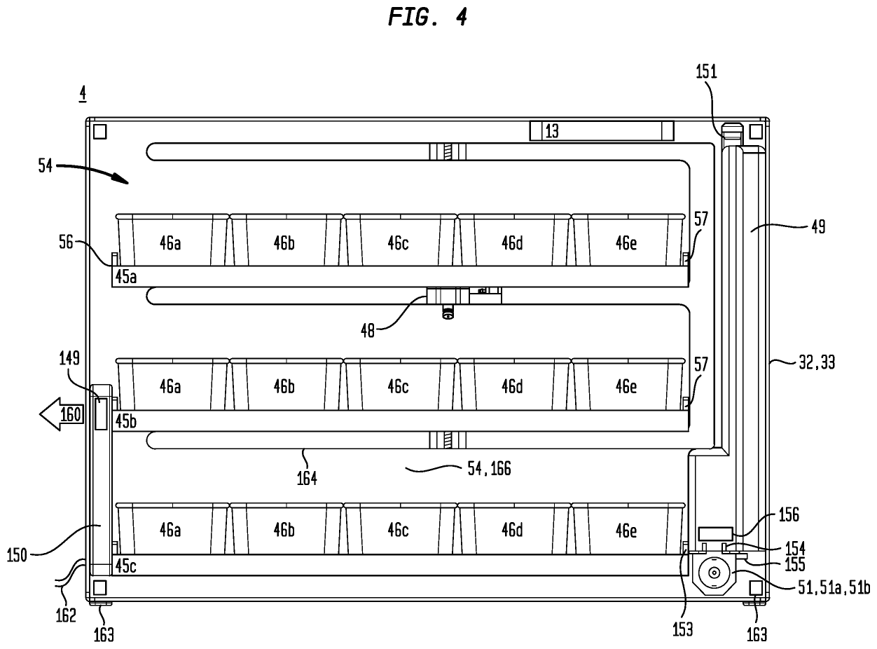

Plant Growing Apparatus. As illustrated by FIGS. 2 and 3, embodiments of the plant growing apparatus (4) can have different outward design appearance depending on design preference, consumer purchasing power, geographic location, and jurisdiction specific statues, rules and regulations. Now, with primary reference to FIGS. 4 through 11, embodiments can, but need not necessarily, include an internal framework (32) of interconnected frame members (33) configured to support various components of the plant growing apparatus (4). In the particular embodiment shown in the FIGS. 4 through 9, the interconnected frame members (33) can define a pair of frame ends (34)(35) disposed in opposed relation a distance apart by a plurality of cross members (36). In particular embodiments, each of the pair of frame ends (34)(35) can include a plurality of first frame end members (37) and a plurality of second frame end members (38) interconnectable to provide the first end frame (34) and a second end frame (35) respectively. While the Figures depict the pair of frame ends (34)(35) as being a substantially planar rectangular, or a planar rectangular pair of frame ends (34)(35), this is not intended to preclude a pair of frame ends (34)(35) differently configured depending on the application. The frame members (33) can further include one or more of: a top rear cross member (39), a top front cross member (40), a bottom rear cross member (41), a bottom front cross member (42), each having a length disposed between first and second frame member ends (43)(44) joinable to the first frame end (34) and the second frame end (35) to dispose the first and second frame ends (34)(35) a distance apart. The frame members (33) can, but need not necessarily be, tubular or angled members. Additionally, while the Figures generally depict the framework (32) as being a rectangular volume; this is not intended to preclude embodiments in which the framework (32) which can be configured in any other configuration, based upon the application. For example, the framework (32) may be open on one or more of the top, bottom, one or both sides or one or both ends, as shown in the illustrative external configuration of FIG. 2. As one illustrative example, the front side and one or both ends may be partially or entirely open in and external panels (55) and one or more internal panels (54) can be interconnected to support various components of the plant growing apparatus (4).

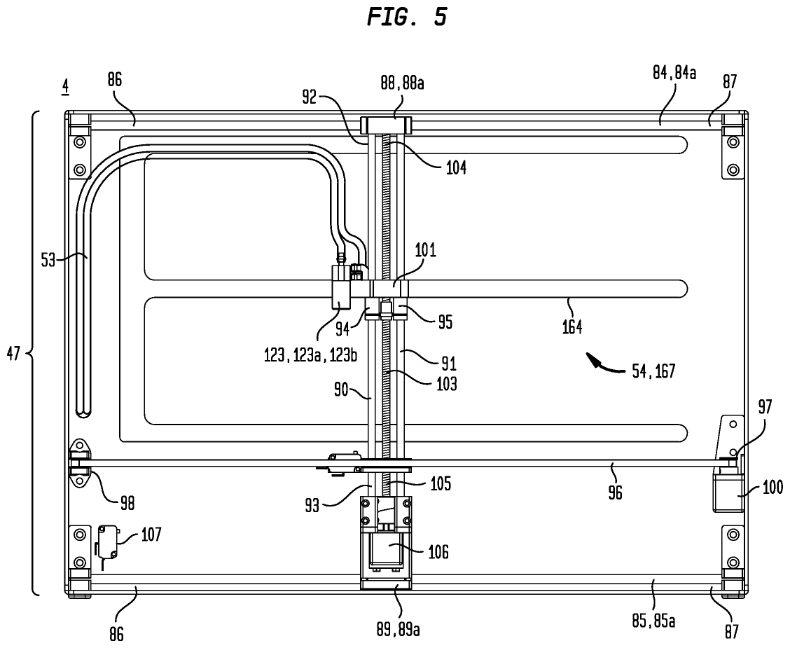

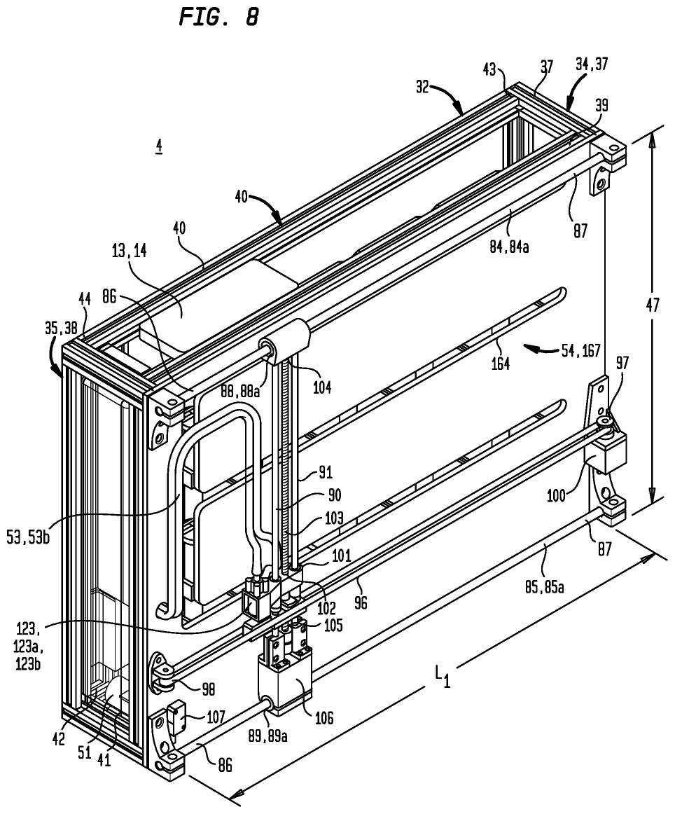

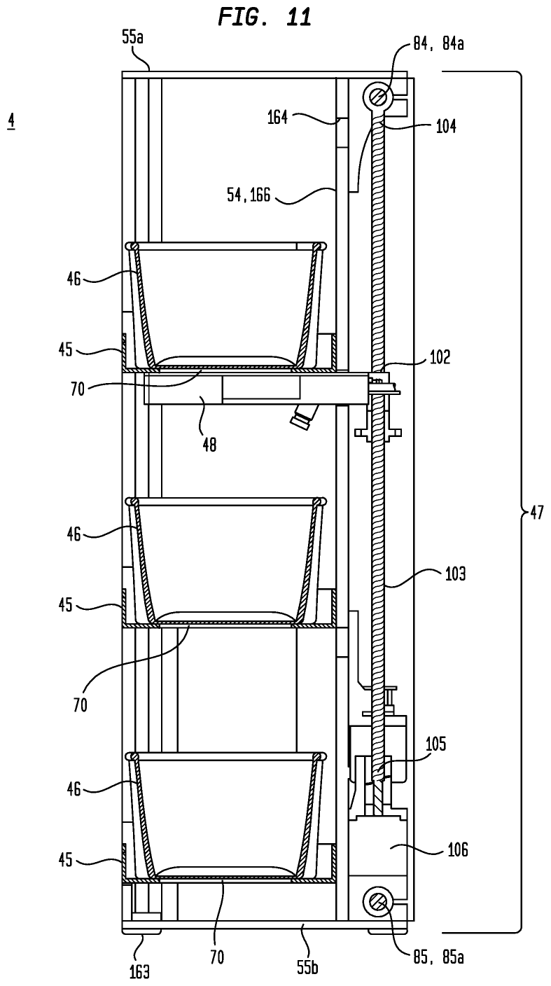

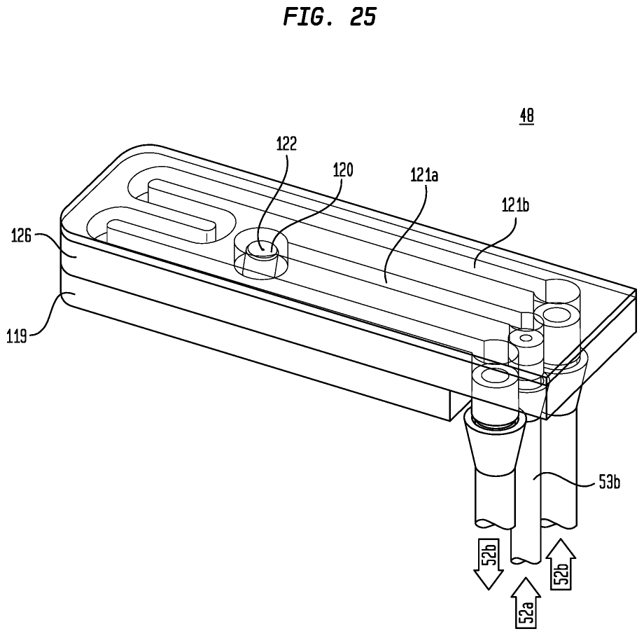

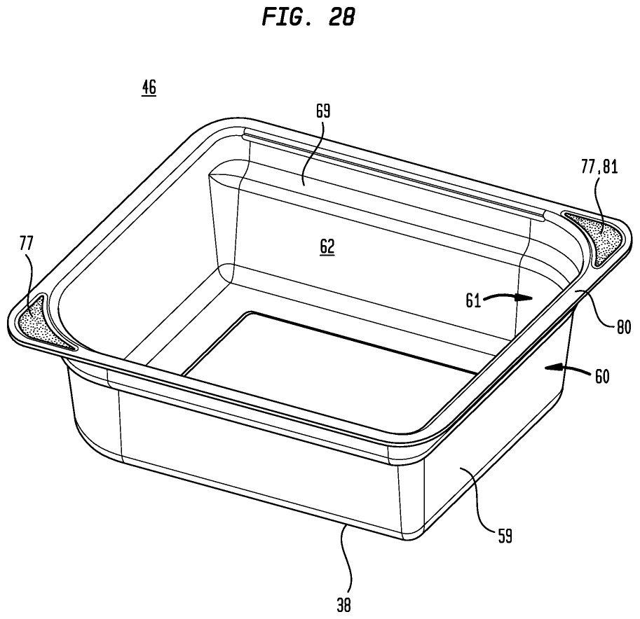

Again, with primary reference to FIGS. 1 through 27, the external panels (55, 55a . . . 55h) interconnected to one or more internal panels (54) or the framework (32) can be configured to support various components of the plant growing apparatus (4) including one or more of: one or more shelves (45, 45a . . . 45c) each configured to support one or more plant growing trays (46) (as shown in the example of FIGS. 2 and 3) (46a through 46e on each shelf (45), an X axis, Y axis or X-Y axis head movement mechanism (47) as shown in the example of FIGS. 5 through 10); a head unit (48) moved by an X-Y head movement mechanism (47) (as shown in the examples of FIGS. 11 through 23); a head unit (48) moved by the head movement mechanism (47) (as shown in the examples of FIGS. 24 through 27); a fluid container (49) which can contain an amount of fluid (50) (as shown in the illustrative example of FIGS. 1 and 4); one or more fluid flow generator (51, 51a, 51b) that generate a fluid flow (52) in one or more fluid flow conduits (53) between the fluid container (49) and the head unit (48)(as shown in the examples of FIGS. 1, and 4 through 10); the plant growing apparatus controller (13) including the controller processor (14) in communication with the controller non-transitory computer readable medium (15) containing in whole or in part the program (12) (as shown in the illustrative examples of FIGS. 1 and 8); a plant growing apparatus user interface (17) which can receive user indications (16) to activate the controller (13) to implement one or more functions of the plant growing apparatus (4) (as shown in the examples of FIGS. 1 through 3); one or more internal panels (54) (as shown in the examples of FIGS. 4, 5, and 8 through 10); and one or more external panels (55) (as shown in the example of FIGS. 2 and 3).

Shelves. Now, with primary reference to FIGS. 2 through 4, embodiments of the plant growing apparatus (4) can include one or more shelves (45) disposed in primarily horizontal orientation inside the plant growing apparatus (4). As used herein, “primarily horizontal” means more horizontal than vertical and “primarily vertical” means more vertical than horizontal in relation to surface supporting the plant growing apparatus (4). Typically, each of the one or more shelves (45) has a shelf length disposed between a pair of shelf ends (56)(57). In the embodiments shown by the Figures, the plant growing apparatus (4) includes three shelves (45a, 45b, 45c) each disposed in primarily horizontal relation and in vertical spaced apart relation inside of the plant growing apparatus (4). Each of the one or more shelves (45) can be configured to support one or more plant growing trays (46a, 46b, 46c, 46d . . . 46n).

Plant Growing Trays. Now, with primary reference to FIGS. 28 through 31, embodiments can include one or more plant growing trays (46). Now, with primary reference to FIG. 28, each of the one or more plant growing trays (46) can each include a tray bottom (58) joined to a tray sidewall (59). The tray bottom (58) and tray sidewall (59) define a tray exterior surface (60) and a tray interior surface (61) defining a tray interior space (62). The one or more trays (46) can have a configuration adapted to reside inside the plant growing apparatus (4) supported by the one or more shelves (45).

In particular embodiments, the tray sidewall (59) can further include an outwardly extending shoulder (69) which extends circumferentially in part or in whole about the tray sidewall (59). The one or more shelves (45) can each include one or more tray pass throughs (70) each configured to allow a tray bottom (58) to passthrough until the shoulder (69) engages the shelf (45). In particular embodiments, one or more of the shelves (45), the plant growing tray (46), the tray passthrough (70) and the tray bottom (58) or the tray sidewall (59) (or a combination thereof) can be configured to only allow the plant growing tray (46) to have a single spatial orientation in relation to the plant growing apparatus (4) (as shown in the example of FIG. 2).

In particular embodiments, the plant growing tray (46) can include visual, machine readable form or radio frequency identification form tray data (77) that can be scanned by a tray data sensor or reader (78), processed and correlated by the program (12) with a plant growth profile (79) that can be further processed to activate functions of the plant growing apparatus (4) with respect to the maintenance of the plant growing tray (46) associated with the plant growing profile (79). The tray data (77) in visual machine-readable form can as illustrative examples be one or more of: a bar code, quick response code, product codes, color codes. The tray data (77) in radio frequency identification form includes digital data captured by the tray data reader (78). In the illustrative example of FIGS. 22 through 25, the plant growing tray (46) can further include an outwardly extending tray sidewall rim (80) including the machine-readable form tray data (77) that can be screened by a tray data sensor (78) that generates a tray data signal (83) corresponding to the tray data (77) that can be associated by operation of the program (12) with a plant growing profile (79). The plant growing profile (79) can be further processed to activate the plant growing apparatus (4) to interact with the plant growing tray (46) to maintain incident moisture and light at the scanned plant growing tray (46) at the levels consistent with the plant growing profile (79).

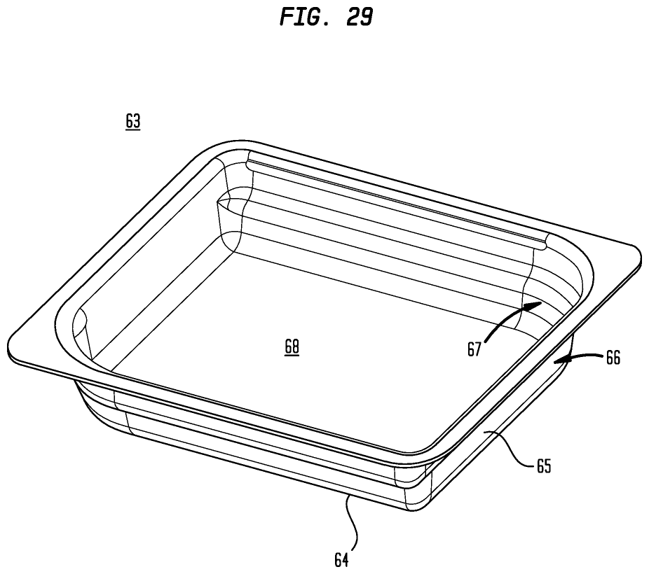

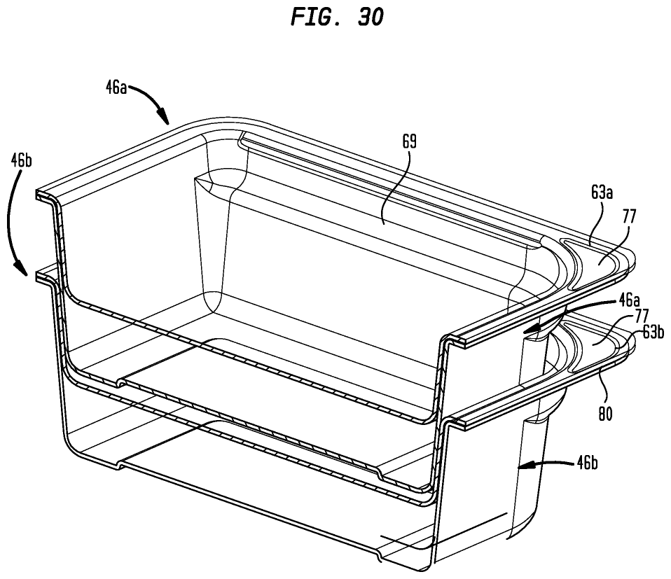

Now, with primary reference to FIG. 29, embodiments can, but need not necessarily include, a tray lid (63) having a tray lid bottom (64) joined to a tray lid sidewall (65). The tray lid bottom (64) and the tray lid sidewall (65) define a tray lid exterior surface (66) and a tray lid interior surface (67) defining a tray lid interior space (68). The tray lid exterior surface (66) of the tray lid sidewall (65) can be configured to engage a tray sidewall interior surface (61) to enclose the tray interior space (62). The tray lid interior surface (67) can be configured to receive and engage the tray bottom (64) or tray sidewall (59) to allow a plurality of trays (46a, 46b) closed by a corresponding plurality of lids (63a, 63b) to be stacked in substantially fixed spatial arrangement (as shown in the example of FIG. 30).

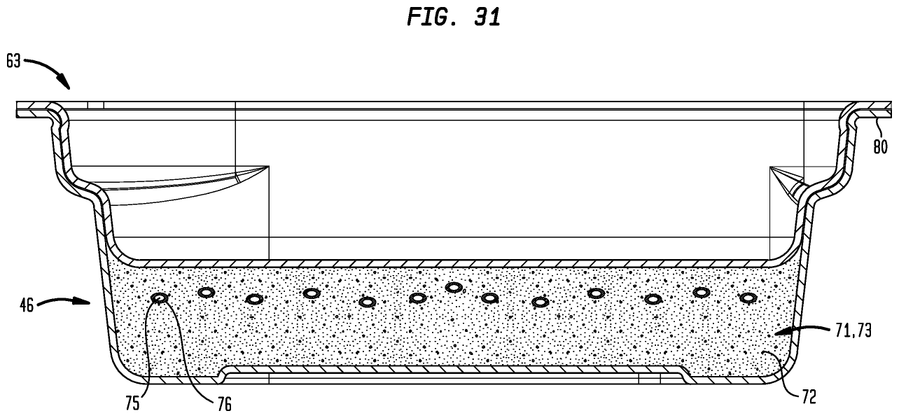

Now, with primary reference to FIG. 31, in particular embodiments, a plant growing medium (71) can be disposed inside the tray interior space (62) of the plant growing tray (46) (as shown in the example of FIG. 24). The plant growing medium (71) can include nutrients (72) and can be adjusted to a particular pH (73) depending on the species of plant (74) to be grown in the plant growing tray (46). As illustrative examples, the plant growing medium (71) can be a soil comprising mixture of organic and inorganic materials, gases, liquids, organisms that support growth of a plant (74) including as illustrative examples, peat, perlite, vermiculite, coco coir, enzymes, micro rhizomes, and combinations thereof. The soil may be blended or may comprise discrete separate layers in the plant growing tray (46). The plant growing medium (71) may be different to match individual plant growing conditions for seeds of different species of plants (74).

Seeds (75) for the corresponding species of plant (74) can be disposed in the proper spacing and at the proper depth in the plant growing medium (71). In particular embodiments, the seeds (75) can be held in the plant growing medium (71) inside the plant growing tray (46) in a substantially fixed spatial relation by a fixing agent (76) applied to the seeds (75) (as shown in the example of FIG. 24). As an illustrative example, the fixing agent (76) can be a mixed solution of starch and water with sufficient starch content to allow the seeds (75) to adhere to the plant growing medium (71) (for example, four to eight percentage of starch by weight). This example is not meant to preclude the use of other fixing agents (76), such as: oil-water lamellar emulsions, methyl cellulose, gum arabic, xanthan gum, clay, lime, or the like.

In particular embodiments, the tray lid sidewall (65) when engaged with the tray sidewall (59) engages the tray lid bottom (64) with the plant growing medium (71) to compress the plant growing medium (71) to hold the seeds (75) in a substantially fixed spatial relation in the plant growing medium (71) (as shown in the example of FIG. 24). In particular embodiments, including, but not necessarily limited to, mycelium inoculated grow medium, the tray lid (63) joined to the plant growing tray (46) can be water and air resistant to retain correct moisture and air in plant growing medium (71).

X-Y Head Movement Mechanism. Now, with primary reference to FIGS. 5 through 11, embodiments of the plant growing apparatus (4) can further include an X-Y movement mechanism (47) (two-dimensional movement in the XY plane that contains the x axis vertical plane and y axis horizontal plane). However, this illustrative example is not intended to preclude embodiments, that may include only a one-dimensional X axis or Y axis movement mechanism, or an X-Y-Z movement mechanism (three-dimensional movement in x axis vertical (X), y axis horizontal (Y), or z axis depth (Z)) or may include a fourth axis (rotation around the x axis) or a fifth axis (rotation around the y axis). In the illustrative example of FIGS. 5 through 11, the X-Y head movement mechanism (47) can include a first pair of slide rails (84)(85) each having a slide rail length (L1)(as depicted in FIG. 8) disposed between a first pair slide rail ends (86)(87) on which one of a first pair of sliders (88)(89) can correspondingly travel. In particular embodiments, each of the first pair of slide rails (84)(85) can be a shaft (84a)(85a) circular in transverse cross section to the longitudinal axis of the shaft (84a)(85a) and each of the first pair of sliders (88)(89) can be a linear bearing (88a)(89a) which travels on the shaft (84a)(85a); however this not intended to preclude other embodiments of the first pair of slide rails (84)(85) having cross sections or other configurations which can be oriented along a primarily horizontal Y-axis and allow reciprocal movement of the corresponding first pair of sliders (88)(89) along the Y-axis affording horizontal movement in the XY head movement mechanism (47). The first pair of slide rails (84)(85) can be coupled in substantially parallel relation a distance apart to the framework (32). A second pair of slide rails (90)(91) each having a length disposed between a second pair of slide rail ends (92)(93) can be coupled a distance apart in primarily vertical orientation. One of a second pair of sliders (94)(95) can correspondingly travel along one of the second pair of rails (90)(91). In particular embodiments, the second pair of slide rails (90)(91) can be coupled to the first pair of sliders (88)(89), whereby movement of the first pair of sliders (88)(89) results corresponding movement of the second pair of rails (90)(91).

Again, with primary reference to FIGS. 5, 8, 9 and 10, in particular embodiments, the first pair of sliders (88)(89) can be coupled to a drive belt (96) comprising a loop of flexible material or links disposed about each of a pair of rotatable members (97)(98) with one of the pair of rotatable members (97)(98) disposed proximate opposite frame ends (34)(35). As one illustrative example, the drive belt (96) can comprise a toothed rubber belt which mates to the pair of rotatable members (97)(98) in the form of toothed pulley. Each of the pair of rotatable members (97)(98) can be driven in the clockwise direction or counterclockwise direction to generate corresponding movement in a first or second direction of the drive belt (96) coupled to the first pair of sliders (88)(89) to drive the first pair of sliders (88)(89) along first pair of slide rails (84)(85) along the Y-axis of the X-Y head movement mechanism (47). One of the pair of rotatable members (97)(98) can be rotationally responsive to a drive shaft (99) of a first stepper motor (100) which divides a full rotation in a number of equal steps which can be controlled by the plant growing apparatus controller (13) to rotate one step at a time allowing precise rotational positioning and speed control of the first pair of sliders (88)(89) along the first pair of slide rails (84)(85).

Again, with primary reference to FIGS. 5, 8, 9 and 10, the second pair of sliders (94)(95) can be coupled to a platen (101) have a threaded bore (102) which mates with a threaded lead screw (103). Rotation of threaded lead screw (103) correspondingly moves the platen (101) and the second pair of sliders (94)(95) along the second pair of slide rails (90)(91). In the illustrative embodiment shown in the Figures, the lead screw (103) can have a length disposed between a lead screw first end (104) rotatably coupled to a first one of the first pair of sliders (88)) and a lead screw second end (105) rotatably coupled to a second one of the first pair of sliders (89). Thus, clockwise or counterclockwise rotation of the threaded lead screw (103) drives the platen (101) which correspondingly generates travel of the second pair of sliders (94)(95) along the second pair of rails (90)(91) in a primarily vertical direction along the X-axis of the X-Y head movement mechanism (47). The threaded lead screw (103) can be driven by a second stepper motor (106) allowing precise rotational positioning and speed control of the second pair of sliders (94)(95) along the second pair of slide rails (90)(91).

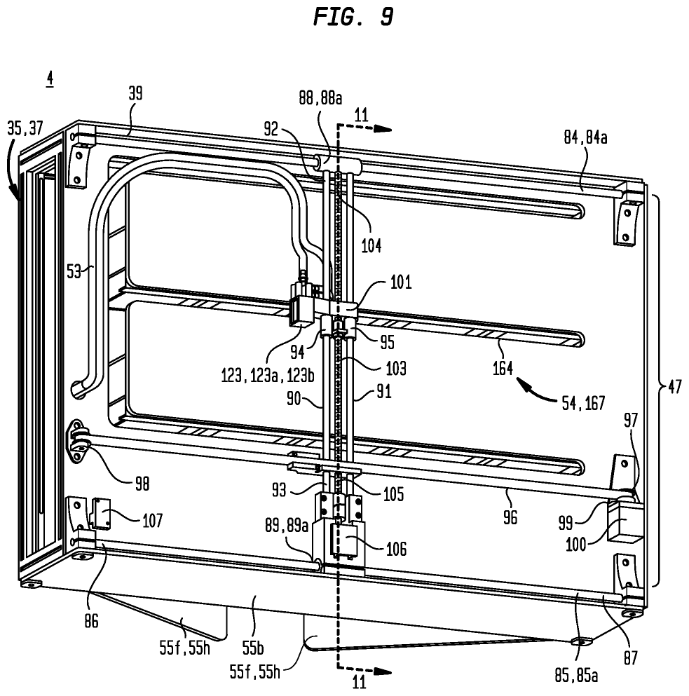

Again, with primary reference to FIGS. 5, 8, 9 and 10, the X-Y head movement mechanism (47) can further include motion sensors (107) (as shown in the example of FIGS. 5 and 9) such as: limit switches, proximity sensors, hall sensors, or other types sensors coupled to the frame work (32) or internal panel (54) to detect contact with or sense movement of the first pair of sliders (88)(89) and the second pair of sliders (94)(95) to establish a home position of the X-Y head movement mechanism (47) from which controlled incremental movement can be made by operation of the first and second stepper motors (100)(106) (or other form of motor or motor and gearbox). The head unit (13) can be joined to the platen (101) coupled to the second pair of sliders (94)(95) and thereby move in the Y-axis in response to travel of the first pair of sliders (88)(89) along the first pair of slide rails (84)(85) and travel in the X-axis is response to travel of the second pair of sliders (94)(95) along the second pair of slide rails (90)(91). Thus, the head unit (13) may move only in the Y-axis, only in the X-axis, or concurrently in both the Y-axis and the X-axis of the X-Y head movement mechanism (47).

Head Unit. Now, with primary reference to FIGS. 1, and 12 through 27, in particular embodiments, the plant growing apparatus controller (13) operates the first or second motors (100)(106) to generate movement of the X-Y mechanism and corresponding movement of the head unit (48). The controller (13) can dispose the X-Y mechanism (47) at a home position at startup. The controller (13) then operates the X-Y mechanism (47) to move the head unit (48) in relation to each of the plurality of shelves (45). In particular embodiments, the controller (13) maintains a constant X-axis speed and a constant Y-axis speed. Upon sensing one of a plurality of plant growing trays (46) positioned on one of the plurality of shelves (45), the controller (13) may move the head unit (48) to the center of the plant growing tray (46) to perform maintenance of the plant growing tray (46) in accordance with the plant growing profile (79) associated with the tray data (77). In particular embodiments, if a plant growing tray (46) is not sensed on a shelf (45), the controller (13) can operate the X-Y mechanism (47) to skip that shelf (45) until a period of time elapses (as an example, one hour elapses before the controller (13) moves the head unit (48) over the shelf (45) that prior lacked any of the plurality of trays (46), and the controller (13) can automatically adjust travel of the head unit (48) in relation to the remaining shelves (45) to maintain the same periodicity between travels over each remaining shelf (45), as if the head unit (48) traveled over all of the shelves (45).

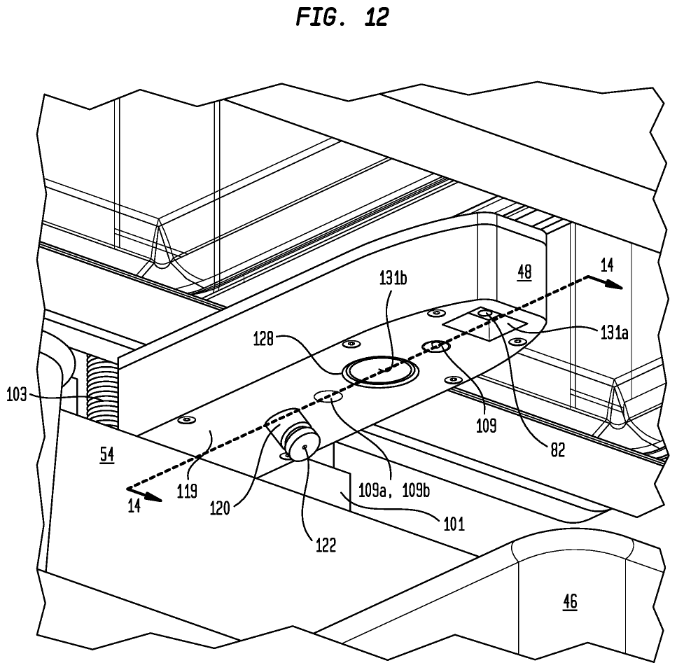

Now, with primary reference to FIGS. 1, 12 through 15, and 24 through 27, particular embodiments of the head unit (48) can include a tray data sensor (82) configured to sense the tray data (77) (as shown in the examples of FIGS. 12 and 14 through 15) included on the plant growing tray (46) in visual, machine readable format, as above described. The tray data sensor (82) can scan the tray data (77) and generate a tray data sensor signal (83) that can be processed by the program (12) and correlated by the program (12) with a plant growth profile (79) which for the sensed plant growing tray (46) adjusts operation of the plant growing apparatus (4) in accordance with the plant growing profile (79) to afford the level, periodicity, quantity or quality of each a plurality of plant growth parameters (108), including as examples one or more of: temperature, humidity, light, water, and nutrition. In particular embodiments, as illustrated by FIGS. 24 through 27, an image capture device (109) can generate image capture data (111) which can function similarly to the tray data sensor (82) to scan the tray data (77) and function similarly to generate a tray data sensor signal (83) that can be processed by the program (12).

Again, with primary reference to FIGS. 1, 12 through 15, and 24 through 27, particular embodiments of the head unit (48) can include one or more of: an image capture device (109), a proximity sensor (109a) or a color sensor (for example, xyz or true color sensor, multispectral sensor, red-blue-green sensor, mini-spectrometer, wavelength spectrum sensor) (109b) which, as the head unit (48) becomes positioned over each plant growing tray (46) by operation of the X-Y head movement mechanism (47), and generates image capture data (111) (or generate proximity sensor data (111a) or color sensor data (111b) which can in association with the tray data (77) allows image capture data (111), proximity sensor data (111a), or color sensor data (111b) to be compared over a plant growth time period (112) to a corresponding plurality of plant growing tray templates (113) retrieved from a plant growing tray image database (114) for the corresponding plant growth time period (112). Accordingly, the degree of correspondence between a plant growing tray data (111, 111a, 111b) and to one or more of the plant growing tray templates (113) can serve to differentiate actual plant growth (115) for each plant growing tray (46) from expected plant growth (116) for each of the plant growing trays (46) over the plan growth time period (112). Anomalies (non-repeatable differences) and repeated deviations in actual plant growth (115) from the expected plant growth (116) based on comparison to the plant growth templates (113) can be further correlated by operation of the program (12) to: identify malfunctions of the plant growing apparatus (4) to provide plant growing apparatus malfunction alerts (117) or plant growth deficiency alerts (118) to the user (21), or to adjust one or more plant growth parameters (108) associated with a plant growing profile (79) for the sensed plant growing tray (46) to narrow the deviation in actual plant growth (115) from expected plant growth (116), or to identify and provide plant harvest alerts (172) to harvest plants (74).

Again, with primary reference to FIGS. 1, 12 through 15, and 24 through 27, the head unit (48) can include a head unit housing (119) configured to support a nozzle (120) having an internal flow path (121a) which communicates with a nozzle aperture (122) through which a first fluid flow (52a) can be dispersed from the head unit (48) directed toward the trays (46) supported on the shelves (45) of the plant growing apparatus (4). One illustrative example of a nozzle (120) suitable for use with embodiments, can, but need not necessarily, be a Uxcell misting nozzle having an orifice (122) of about 0.2 millimeter diameter.

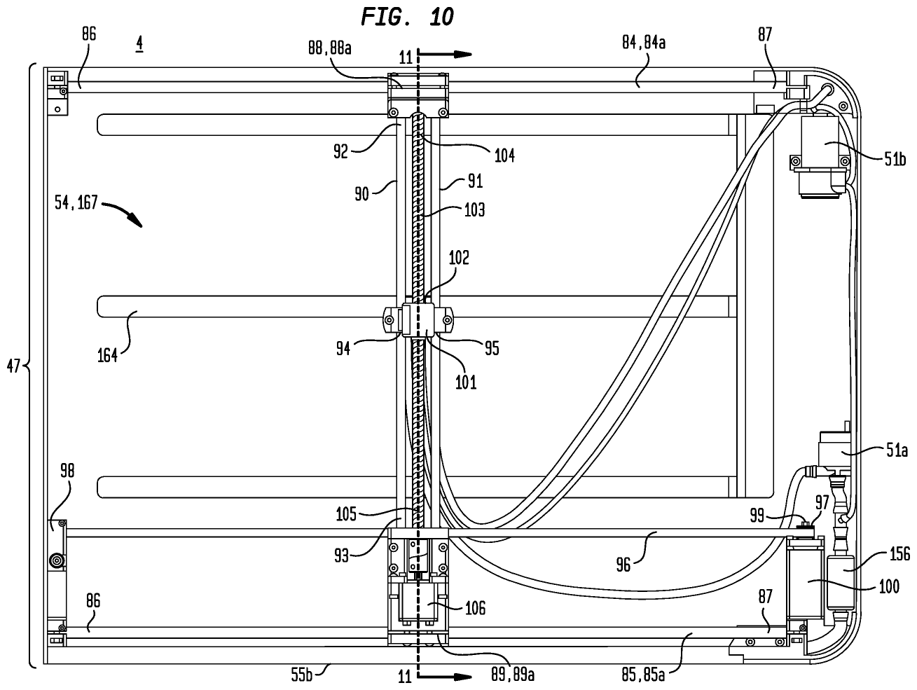

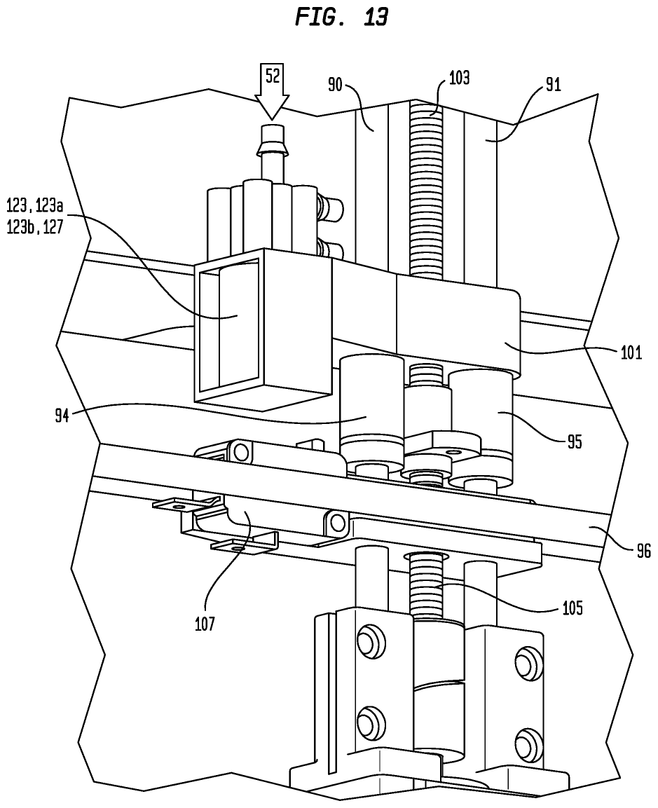

In particular embodiments, the first fluid flow (52a) to the nozzle (120) can be interrupted by operation of a first valve (123) between an open condition and a closed condition (as shown in the example of FIG. 13). As one example, the first valve (123) can comprise a solenoid valve (123a) which can be controlled between the open and closed condition by switched operation of electromagnet that draws a plunger or a pivoted armature to engage or disengage a valve seal from a valve seat. As one illustrative example, a solenoid valve 2 position 3 way normally open valve (123b) is depicted in the illustrative example of FIG. 13. In particular embodiments, as shown in FIGS. 10, and 24 through 27, the first fluid flow (52a) can be interrupted by ceasing operation of the first fluid flow generator (51a) (as shown in the example of FIG. 10) obviating the necessity of including a first valve (123).

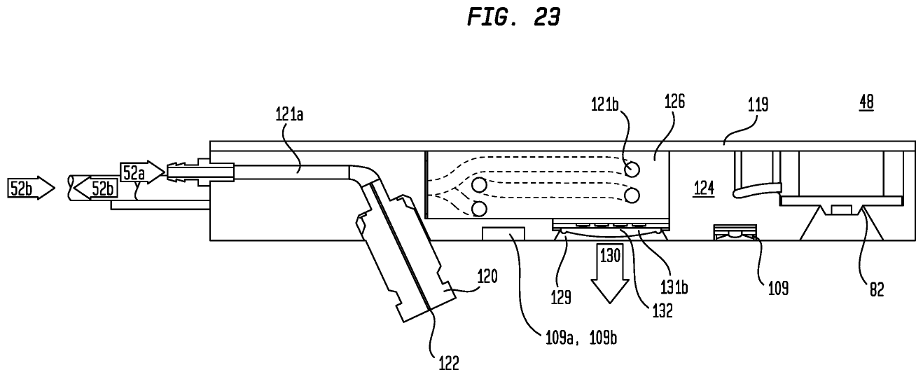

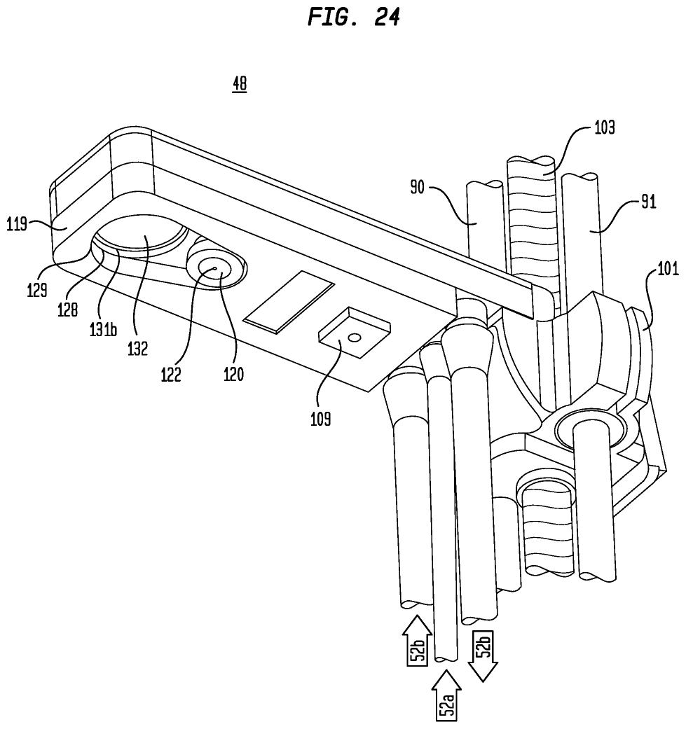

Now, with primary reference to FIG. 23, the head unit housing (119) can be configured to define a housing interior space (124) through which a second flow of fluid (52b) can circulate through the interior space, or can circulate through a recirculating block (126) disposed in the interior space (124) of the head unit housing (119). The second flow of fluid (52b) can serve to cool the head unit (48) or to warm the fluid (50) returned to the fluid container (49). As one illustrative example, the recirculating block (126) can be a hollow aluminum block which may have within a serpentine flow channel (121b). In particular embodiments, a second valve (127) can operate between an open condition and a closed condition to interrupt the second fluid flow (52b) to the housing interior space (124) or recirculating block (126) in the head unit (48). In particular embodiments, the three-way valve (123b) can operate between a first valve condition which allows for the first fluid flow (52a) and interrupts the second fluid flow (52b) and a second valve condition which interrupts the first fluid flow (52a) and allows the second fluid flow (52b).

Now, with primary reference to FIG. 10, in particular embodiments, a first fluid flow generator (51a) can generate the first fluid flow (52a) directly to the nozzle aperture (122) and a second fluid flow generator (51b) can generate the second fluid flow to the recirculating block (126) which can obviate the use of the first valve (123), the second valve (127) or a solenoid valve, for example, 2 position 3 way normally open valve (123b).

Now, with primary reference to FIGS. 10, 12 and 13, the head unit housing (119) can be configured to define an optical aperture (128) defining a housing passthrough (129) that allows emitted light (130) to pass from the housing interior space (124) of the head unit housing (119). In particular embodiments, a reflector (131a) disposed in the housing passthrough (129) can be configured to reflect emitted light (130) over a tray (46)(as shown in the example of FIG. 24). In particular embodiments, an optical window (131b) can be disposed in the optical aperture (128). The optical window (131b) can be transparent or translucent and may be configured to concentrate or disperse the emitted light (130). In particular embodiments, the optical window (131) can be configured to disperse the emitted light (130) over substantially the entire surface of a tray (46) positioned beneath the head unit (48).

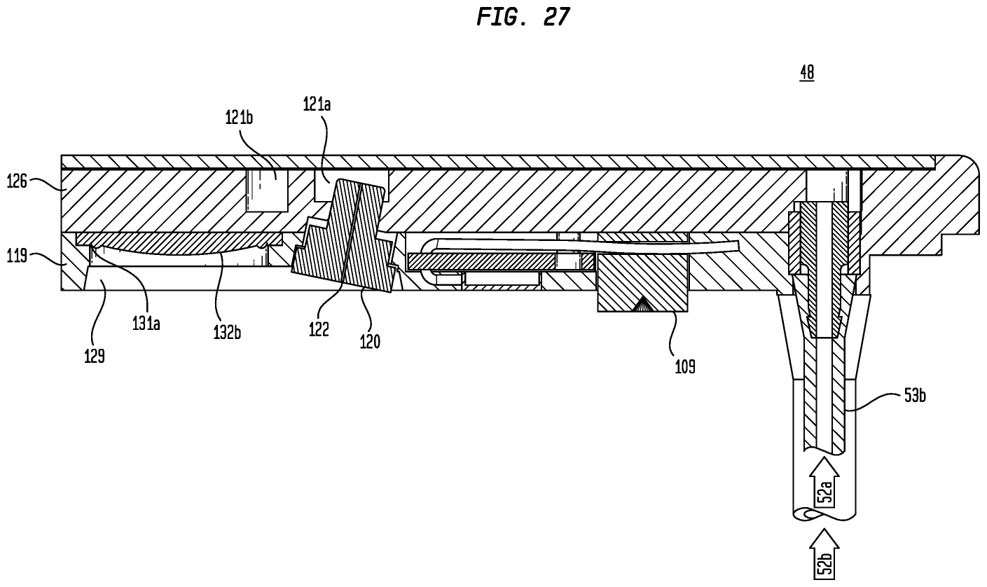

Now, with primary reference to FIG. 1, at least one light emitter (132) can be supported inside the unit head housing (119) to emit light (130), whether directly or by reflection, through the optical aperture (128). The at least one light emitter (132) can be adapted to emit light (130) within a predetermined or selected segment of the electromagnetic spectrum (133), or at one or more pre-determined or user selected wavelength frequencies (134) or wavelength amplitudes (135), and combinations thereof. In particular embodiments, the light emitter (132) can be a solid-state light emitting element formed from organic or inorganic semiconductor materials. As illustrative examples, the light emitter (132) can be a light emitting diode (“LED”) (132a) including all types of semiconductor diode devices that are capable of receiving an electrical signal and producing a responsive output of electromagnetic energy. Thus, the term “LED” should be understood to include light emitting diodes (132a) of all types, light emitting polymers, organic diodes, and the like; however, the illustrative example of the use of LED light emitters (132a) is not intended to preclude other types of light emitters (132) adapted for, capable of, or configured to emit light (130) within the predetermined or selected segment of the electromagnetic spectrum (133). As one illustrative example, a chip on a board (“COB”) LED (132b)(as shown in the example of FIG. 26) may be suitable for particular embodiments of the invention.

Again, with primary reference to FIG. 1, a printed circuit board (“PCB”) (136) can be supported within the head unit (48) to carry one or a plurality of light emitters (132). As one illustrative example, the PBC (136) can carry a plurality of controllable LED light emitters (132a) (red (R), green (G) and blue (B)), or controllable LED light emitter(s) emitting a full or broad spectrum of visible light inclusive of all the wavelengths of visible spectrum (VS). The one or the plurality of light emitters (132)(132a) mounted on the PBC (136) can emit light (130) through the optical aperture (128). The predetermined or selected segment of the electromagnetic spectrum (133) of the emitted light (132) relates to the selected wavelength frequencies (134) while the brightness of the emitted light (132) relates to the and the wavelength amplitude (135). The emitted light (130) from the one or plurality of light emitters (132) can be diffusely reflected or combined within head unit (48) to form an integrated light for emission through the optical aperture (128). The integrated light can combine emitted light (130) from a plurality of light emitters (132) to form a relatively Lambertian distribution across the optical aperture (128) with the visible intensity spread substantially uniformly across the optical aperture (128) and correspondingly across the tray (46), rather than exhibiting pixilation.

Again, with primary reference to FIG. 1, in particular embodiments, the PCB (136) can, but need not necessarily, carry a light color sensor (137) to detect the color spectrum (133) of the emitted light (130) (or integrated light) within the housing interior space (124) to verify that the emitted light (130) has the selected or pre-determined electromagnetic spectrum (133). As an illustrative example, the light color sensor (137) can be an RGB color detector. The RGB color detector can include an array of photodiodes with a portion of the photodiodes having blue filters, a portion having green filters, a portion having red filters and a portion having no filter which detects white light. The light color sensor (137) can in the alternative be a true color sensor suitable for use with broad spectrum white light emitters.

Again, with primary reference to FIG. 1, PCB (136) can include an integrated circuit including the controller (13) responsive to light color data (138) generated by the program (12) in response to the pre-determined or selected segment of the electromagnetic spectrum (134) associated with plant growth profile (79) matched to the tray data (77) on the tray (46), and in particular embodiments responsive to a light color sensor signal (139) generated by the color detector (137) to detect electromagnetic spectrum (133) of the emitted light (130) within the housing interior space (124) or external of the head unit (48). The controller (13) can further include a control circuit (140) electrically coupled to the light emitter(s) (132) operable to adjust emitted light electromagnetic spectrum (133). The control circuit (140) typically includes a power source circuit (141) coupled to the power source (142). The control circuit (140) also includes an appropriate number of light emitter driver circuits (143) for controlling the power applied to each of the different light emitters (132), and thus the wavelength amplitude (135) for each different wavelength frequency (134). In the example of LEDs (132a), the amount of power supplied to each of a plurality of LED driver circuits (143) controls of the intensity of emission of the corresponding LEDs (132a) to establish the spectrum (133) of the emitted light (130) from each LED (132a) and thus the spectrum (133) of the emitted light (130) passing through the optical aperture (128) or optical window (131). In the illustrative example, the wavelength frequencies (134) of the emitted light (130) comprise the emitted light (130) from one or more LEDs (132a). One or more LEDs (132a) can emit light (130) of a first spectrum (133a), and one or more LEDs (132a) can emit light of a second spectrum (133b), wherein the second spectrum (133b) is different from the first spectrum (133a). Similarly, one or more LEDs (132a) can emit light of a third spectrum (133c), a fourth spectrum (133d)(or additional spectrum n), to achieve the highest color rendering index, the LEDs (132a) may include LEDs (132a) of various wavelength frequencies (134) that cover virtually the entire visible spectrum (VS). For example, arbitrary pairs of the LEDs (132a) might emit four different colors of light R, G, B as primary colors and a fourth color chosen to provide an increased variability of the color spectrum (133) of the emitted light (130).

Now, with primary reference to FIG. 1, in particular embodiments, the light emitters (132) operate upon the user (21) turning on the plant growing apparatus (4). In particular embodiments, the controller (13) can maintain fixed illuminated and non-illuminated periods within the plant growing apparatus (4). As to other embodiments, where the user (21) can adjust the wavelength amplitude (135) (brightness) of the emitted light (130), the controller (13) may adjust illuminated and non-illuminated periods within the plant growing apparatus (4) based on the user selected wavelength amplitudes (135) (brightness).

Again, with primary reference to FIG. 1, in particular embodiments, the plant growing apparatus can further include one or more environmental sensors of ambient light, humidity and temperature sensors which correspondingly generate ambient light, humidity and temperature data along with GPS (11) data can be processed and correlated with plant growth profiles (79) to modify operation of the plant growing apparatus (4) with respect to control at least one physical condition of the environment to cultivate plants in plant growing trays (46) associated with the plant growing apparatus (4).

Again, with primary reference to FIG. 1, in particular embodiments, the controller (13) can, but need not necessarily, further operate an electronic data exchanger (22) to exchange, tray data (77), image capture data (111), proximity sensor data (111a), color sensor data (111b), light color sensor signal (139) with a server computer (2) or computing device (3) containing the program (12) in whole or in part. The electronic data exchanger (22) can be in the form of a universal serial bus, or a wireless radio frequency transmitter to afford wired or wireless connection or pairing of the controller (13) with one or a plurality of computing devices (3) over a short-range radio frequency band (9) to carry a signal (26) over all or a part of a communication path (27) between the plant growing apparatus (4) and a server (2) or computing device (3). The short-range frequency band (9) can include as illustrative examples: BLUETOOTH® (28) which operates at frequencies of about 2402 MHz to about 2480 MHz, or about 2400 MHz to about 2483.5 MHz, or WI-FI® (29) which operates at about 2.4 GHz or 5 GHz. The controller (13) can also govern power management to measure and allocate voltages of a power source (142).

Power Source. Now, with primary reference to FIGS. 1, 2 and 3, embodiments of the plant growing apparatus (4) can operate with a power source (142) of 120 volt-alternating current or low voltage battery (144), such as a 5 Volt (“V”) battery, a 9 V battery, or a 12 V battery, or combination thereof, interruptible by an on-off switch (165). Power can be supplied to a power source circuit (141) either by a low voltage battery (144) and a step-up converter (145) for stand-alone operation, or by electrical power conductors of the household wiring to receive primary power from the standard 120-volt, 60 cycle AC signal (146), and in the event of a loss of primary power, the battery (144) can provide backup power. As one illustrative example, the power source (142) can be standard 120 volt 60 cycle AC signal (146) which can be transformed by a low voltage section including a series connected capacitors and resistors to limit the available current to a diode which limits the voltage to low voltage such as 9 volts, and a filter capacitor can remove voltage ripple. The diode can limit the current to an LED power on indicator (147), and an LED alarm indicator (148), and provide power to the controller (13), light emitter driver circuits (143), light emitters (132), the data exchanger (22), equipment cooling fans (149), and other low voltage components. The power supply circuit (141) can be contained in a power supply circuit housing (150) with air circulation by an equipment cooling fan (149), such as a muffin fan. In the illustrative example of FIG. 3, the power supply circuit housing (150) can be disposed proximate to one of the pair of frame ends (34)(35).

Water Supply. Now, with primary reference to FIGS. 1, and 4 through 9, in particular embodiments, a fluid container (49) can be configured to reside in whole or in part inside of frame end open area of one of the pair end frames (34)(35); however, this is not intended to preclude embodiments which are connected to an external fluid source. The fluid container (49) can further include a fluid inlet (151) for recharging the container (49) with fluid (50) and can further include a fluid outlet (152) and may further include a valved drain port (153) to allow the user to drain fluid (50) from the fluid container (49). In particular embodiments, a fluid level sensor (125a) can be coupled to the fluid container (49) to sense the fluid level in the fluid container (49). The fluid (50) will typically be household water or an aqueous solution of plant nutrients including as examples: nitrogen, phosphorous, calcium, magnesium, sulfur and trace elements at a pH typically occurring in a range of between 5.0 pH to 7.6 pH.

In particular embodiments, the container outlet (152) can be fluidically coupled by a fluid flow conduit (53a) to a fluid flow generator inlet (154) of a fluid flow generator (51). The fluid flow generator (51) depicted in the Figures can, but need not necessarily, be a peristaltic pump or metering pump which may have a dosing head that moves precise volumes of fluid in a specified time period. A fluid flow generator outlet (155) can be fluidically coupled by a fluid flow conduit (53b) to the head unit (48) for delivery of fluid (50) to the nozzle (120), or for recirculation through the cooling block (126). As shown in the illustrative example of FIGS. 8, 9, and 23, the fluid flow conduit (53b) can be coupled between the fluid flow generator outlet (155) and a three-way valve (123b) which operates between a first valve condition to allow a first fluid flow (52a) to the nozzle (120) and interrupts the second fluid flow (52b) to the cooling block (126) and a second valve condition which interrupts the first fluid flow (52a) to the nozzle (120) and allows the second fluid flow (52b) to recirculate through the cooling block (126) with return to the container (49). In particular embodiments, the fluid flow conduit (53) can comprise a silicone tube of about two millimeter internal diameter and about four millimeter outside diameter.

Now, with primary reference to FIGS. 1 and 9, in particular embodiments, the container outlet (152) can be fluidically coupled by a fluid flow conduit (53b) to a fluid flow generator inlet (154a) of a first fluid flow generator (51a). The first fluid flow generator (51a) depicted in the Figures can, but need not necessarily, be a peristaltic pump or metering pump which may have a dosing head that moves precise volumes of fluid in a specified time period. A fluid flow generator outlet (155) can be fluidically coupled by a fluid flow conduit (53b) to the head unit (48) for delivery of fluid (50) to the nozzle (120). The container outlet (152) can also be fluidically coupled by a fluid flow conduit (53b) to a fluid flow generator inlet (154b) of a second fluid flow generator (51b) for recirculation through the cooling block (126) and return to the fluid container (49).

In particular embodiments, a fluid filter (156) can be interposed between the fluid container (49) and the first fluid flow generator (51a) and the second fluid flow generator (52b). The fluid filter (156) captures particles in the fluid (50) that would restrict or interrupt fluid flow (52) in the first fluid flow generator (51a), the second fluid flow generator (51b), the fluid flow conduit (53a, 53b), the head unit (48), the recirculating block (126), or the nozzle (120).

In particular embodiments, the fluid container (49) can be removably coupled to the plant growing apparatus (4) so that the fluid container (49) may be lifted away from the plant growing apparatus (4), refilled, and then returned to the plant growing apparatus (4). The fluid container (49) or plant growing apparatus. In particular embodiments, the plant growing apparatus (4) can further include a fluid container detection sensor (125b) to detect the fluid container (49) when coupled to the plant growing apparatus (4). The control program (12) can include a fluid generator inactivate function (173) to turn off the first fluid flow generator (51a) and the second fluid flow generator (51b), upon removal of the fluid container (49) from the plant growing apparatus (4). Illustrative examples of a fluid container detection sensor (125b) can include: a hall sensor, a proximity sensor, or a physical limit switch sensor, or combinations thereof.

Exterior Panels. Now, with primary reference to FIGS. 2 and 3, external panels (55), including one or more of: a top panel (55a), a bottom panel (55b), a first end panel (55c), a second end panel (55d), and a front panel (55e) or one or more hinged front panels (55f), a front side panel (55h), and a rear panel (55i), and combinations thereof, can be coupled or hingedly coupled, or removably coupled to the framework (32). In the illustrative example, the front panels (55f) can include first and second hinged front panels (55g)(55h) which operate between a closed condition and an open condition by which trays (46) can be disposed on the shelves (45) and a front side panel (54i) into which the user interface (17) mounts to receive user indications (16) to operate the grow apparatus (4). The hinged front panels (54g, 54h) can be made from a transparent or translucent material to allow the user (21) to visualize the interior of the plant growing apparatus (4). In particular embodiments, the front panel(s) (54g, 54h) can be comprised or include a layer of electrochromic material (171) that changes color in response to an oxidizing voltage to mask illumination of the plant growing apparatus (4). The first end panel (54c) which covers the fluid container (49) can have one or more fluid level visualization apertures (157) allowing the user to visualize the level of the fluid (50) in the fluid container (49). Top panel (54a) can have one or more fluid container filling apertures (158). The second end panel (54d) that covers the power supply circuit housing (150) can a have air recirculation apertures (159) to promote air flow (160) to or from the power supply circuit housing (159) and a power cord receptacle (161) to receive or from which a power cord (162) extends. The bottom panel (54b) will typically include an elastomer foot (163) proximate each corner which may leveling feet. The back panel (54j) can comprise an internal back panel (54) and an external back panel (55). The internal back panel (54) visually obscures the X-Y head movement mechanism (47) from the user (21) front view of the plant growing apparatus (4). The X-Y head movement mechanism (47) can mount over the internal back panel (54). The internal back panel (54) includes a head travel slot (164) open to opposite internal back panel faces (166)(167) configured to allow the head unit (48) to extend through the head travel slot (164) and travel vertically and horizontally to dispose the head unit (48) above each of the plurality plant growing trays (46) disposed on a corresponding plurality of shelves (45). The external back panel (55) couples to the framework (32) to cover the user (21) back elevation view of the X-Y head movement mechanism (47). Mounting brackets can be disposed on the external surface of the plant growing apparatus (4) to allow securement to a support surface such as a horizontal or vertical wall surface.

User Interface. Now, with primary reference to FIGS. 1, 2 and 3, the controller (13) can be responsive to user indications (16) in a user interface (17) to operate the plant growing apparatus (4). In particular embodiments, the plant growing apparatus user interface (17) may includes only an on-off switch (165) which delivers power to the plant growing apparatus (4) and provides a user indication (16) to the controller to operate the X-Y head movement mechanism (47) to position the head unit (48) over each plant growing tray (46) positioned in the plant growing apparatus (4) and to control the functionalities of the head unit (48) to operate the control circuit (140) to periodically drive the light emitters (132) to illuminate the plant growing apparatus (4) and periodically operate the fluid flow generator (51) to periodically deliver fluid (50) from the fluid container (49) through the nozzle (120) to maintain moisture in the plant growth medium (71) in each plant growing tray (46). In particular embodiments, the user may only provide user indications (16) to control the brightness of the emitted light (130) through contact with a brightness level increase icon (168) or a brightness level increase icon (169). In these embodiments, the controller (13) may sense tray data (77) and correspondingly control light emitters (132) in regard to periodicity of illumination, wavelength frequencies (134) and wavelength amplitude (135)(brightness) and control periodicity and amount of fluid (50) delivered to each plant growing tray (46). In other embodiments the user interface (17) can be depicted on the display surface (170) of a computing device (3) as above described including as to certain embodiments the depiction of modifiable plant growth profiles (79) which can be correspondingly matched with each of the plant growing trays (46) associated tray data (77). In particular embodiments, each plant growing tray (46) can be associated with plant growing tray images (110) which can be depicted on the display surface of the computing device (3).

As can be easily understood from the foregoing, the basic concepts of the present invention may be embodied in a variety of ways. The invention involves numerous and varied embodiments of a plant growing apparatus and methods for making and using such plant growing apparatus including the best mode.

As such, the particular embodiments or elements of the invention disclosed by the description or shown in the figures or tables accompanying this application are not intended to be limiting, but rather illustrative of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “generator” should be understood to encompass disclosure of the act of “generating”—whether explicitly discussed or not—and, conversely, were there effectively disclosure of the act of “generating”, such a disclosure should be understood to encompass disclosure of a “generator” and even a “means for generating.” Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in Merriam-Webster's Collegiate Dictionary, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Thus, the applicant(s) should be understood to claim at least: i) each of the plant growing apparatus herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A plant growing apparatus, comprising:
a head movement mechanism; and
a head unit coupled to said head movement mechanism, said head movement mechanism configured to move said head unit primarily horizontally and/or primarily vertically in relation to the interior space of said plant growing apparatus, wherein said head unit monitors or controls at least one physical condition of said plant growing apparatus.

2. The plant growing apparatus of claim 1, wherein said head movement mechanism includes an X axis head movement mechanism, a Y axis head movement mechanism, or an X-Y axis head movement mechanism.

3. The plant growing apparatus of claim 1, further comprising a nozzle disposed in said head unit, said nozzle configured to disperse a fluid flow in said plant growing apparatus.

4. The plant growing apparatus of claim 3, further comprising a fluid flow generator operable to deliver a fluid flow from a fluid container to said nozzle.

5. The plant growing apparatus of claim 3, wherein said fluid container disposed in said plant growing apparatus, said fluid container adapted to retain an amount of fluid delivered to said nozzle by operation of said fluid flow generator.

6. The plant growing apparatus of claim 1, further comprising one or more light emitters disposed in said head unit, said one or more light emitters operable to emit light in said plant growing apparatus.

7. The plant growing apparatus of claim 6, further comprising a recirculating block disposed in said head unit, said recirculating block fluidically coupled to a fluid flow generator, said fluid flow generator operable to recirculate a fluid flow from said fluid source to said recirculating block with return to said fluid container.

8. The plant growing apparatus of claim 1, further comprising:
a nozzle disposed in said head unit;
a first fluid flow generator fluidically coupled to said nozzle, said first fluid flow generator operable to deliver a first fluid flow from a fluid container to said nozzle to disperse said first fluid flow in said plant growing apparatus;
one or more light emitters disposed in said head unit, said light emitters operable to emit light in said plant growing apparatus; and
a recirculating block disposed in said head unit, said recirculating block fluidically coupled to a second fluid flow generator, said second fluid flow generator operable to recirculate a second fluid flow from said fluid container to said recirculating block with return to said fluid container.

9. The plant growing apparatus of claim 1, further comprising a tray data sensor disposed in said head unit, said tray data sensor configured to sense visual, machine readable form tray data or radio frequency identification data disposed on or transmitted from a plant growing tray positioned in said plant growing apparatus.

10. The plant growing apparatus of claim 1, further comprising an image capture device disposed in said head unit, said image capture device configured to capture images of a plant growing tray positioned in said plant growing apparatus.

11. The plant growing apparatus of claim 1, further comprising a proximity sensor or a color sensor disposed in said head unit, said a proximity sensor or a color sensor configured to sense proximity or color of plants growing in a plant growing tray positioned in said plant growing apparatus.

12. The plant growing apparatus of claim 1, further comprising one or more shelves disposed in substantially horizontal and vertically spaced apart orientation in said plant growing apparatus, said head movement mechanism operable to move said head unit between opposite shelf ends of each shelf.

13. The plant growing apparatus of claim 12, further comprising one or more plant growing trays positioned on each of said one or more shelves, said head unit movable by operation of said head movement mechanism in spatial relation to each of said one or more plant growing trays positioned on each of said one or more shelves.

14. The plant growing apparatus of claim 13, further comprising a controller including a processor in communication with a non-transitory computer readable medium containing a plant growing program.

15. The plant growing apparatus of claim 14, wherein said plant growing program executable to operate said head movement mechanism to move said head in spatial relation to each of said one or more plant growing trays positioned on each of one or more shelves inside of said plant growing apparatus.

16. The plant growing apparatus of claim 15, wherein said plant growing program executable to operate a fluid flow generator to generate a first fluid flow from a fluid container to a nozzle disposed in said head unit, said fluid delivered from said nozzle to said one or more plant growing trays.

17. The plant growing apparatus of claim 15, wherein said plant growing program executable to operate a control circuit electrically coupled to one or more light emitters disposed in said head unit, said control circuit operable to drive said light emitter at a predetermined portion of an electromagnetic spectrum.

18. The plant growing apparatus of claim 17, wherein said control circuit operable to drive said light emitter at a predetermined or selected wavelength frequency and wavelength amplitude.

19. The plant growing apparatus of claim 15, wherein said controller executable to operate a tray data sensor disposed in said head unit to sense tray data disposed on each of said one or more plant growing trays, said tray data of each of said one or more plant growing trays correspondingly matched to a plant growing profile including plant growing parameters associated with seeds contained in each of said one or more plant growing trays.

20. The plant growing apparatus of claim 15, wherein said plant growing program executable to operate an image capture device disposed in said head unit to capture plant growing tray images of said one or more plant growing trays, said plant growing program further executable to compare plant growing tray image data to a plurality of plant growing tray templates retrieved from a plant growing tray image database to assess plant growth in each of said one or more plant growing trays.

21. The plant growing apparatus of claim 15, wherein said plant growing program executable operate a proximity sensor and/or color sensor disposed in said head unit to sense proximity or color of plants growing in each of said one or more plant growing trays, said plant growing program further executable to compare proximity data or color data generated by said proximity and/or color sensors to a plurality of plant growing tray templates retrieved from a plant growing tray image database to assess plant growth in each of said one or more plant growing trays.

22. The plant growing apparatus of any one of claim 21, wherein said plant growing program, based on said comparison of one or more of said plant growing tray image data, said proximity data, or said color data to said plurality of plant growing tray templates, executable to identify differences between actual plant growth and expected plant growth of plants in each of said one or more plant growing trays.

23. The plant growing apparatus of claim 22, wherein said plant growing program executable to adjust said plant growing profile to compensate for less than expected plant growth of plants in each of said one or more plant growing trays.

24-77. (canceled)
